(19) United States
(12) Patent Application Publication
(10) Pub. No.: US 2026/0214144 A1
(43) Pub. Date: Jul. 23, 2026

(54) DATA PLANE OPTIMIZATION FOR MICROSERVICES

(71) Applicant: TELEFONAKTIEBOLAGET LM ERICSSON (PUBL), Stockholm (SE)

(72) Inventors: Sambit Nayak, Bhubaneswar, Orissa (IN); Chakri Padala, Bangalore (IN); Ganapathy Raman Madanagopal, Bengaluru (IN)

(21) Appl. No.: 19/143,281

(22) PCT Filed: Dec. 26, 2022
(86) PCT No.: PCT/IN2022/051128

§ 371 Date: Jun. 25, 2025

(51) Int. Cl. H04L 67/133

(52) U.S. Cl. CPC H04L 67/133

(57) ABSTRACT

Optimizations in the API software layer (e.g., API framework libraries) are provided to avoid API traffic data serialization overheads in scenarios where it is feasible. The optimizations enable an API framework to make a decision whether to serialize an API request or response by utilizing information from the control plane platform (e.g., orchestration system), as well as exchanging information through the existing preamble procedures performed by API frameworks and protocols, before sending the API request or response. Eliminating the need for serialization and deserialization for every request and response reduces data transfer latency and results in savings in processing cycles and power. The modifications to the API framework are transparent to the microservices application and require changes only in the API framework.

### TECHNICAL FIELD

The present disclosure relates generally to cloud-based communication networks and, more particularly, to optimization of the data plane for cloud-based communication networks.

### BACKGROUND

Modern best-practice cloud-native application architectures typically comprise a multitude of loosely coupled software entities-called “microservices”—packaged as containers or Function as services (FaaS), which are deployed and orchestrated by an orchestration system (e.g., Kubernetes) across small-scale or large-scale datacenters. These microservices interact using their well-defined application programming interfaces (API) over one or more technologies like Hypertext Transfer Protocol (HTTP) and Representational State Transfer (REST), Remote Procedure Calls (RPC) (e.g., Google RPC (gRPC)), etc. User requests and external requests are served by front-end microservices that make such API invocations to various self-contained back-end microservices as required to satisfy the requests.

Benefits of this cloud-native architecture include 1) independent deployment and scaling leading to better scalability, 2) fault isolation that results in better resilience, 3) faster and continuous development and deployment cycles, 4) better organizational mapping, and 5) ability to be programming language independent across different microservices.

The data-plane API interactions (requests and responses) between microservices usually involve some form of data serialization. That is, a request is serialized by the caller and “sent” to the callee, where it is deserialized. The callee processes the request and serializes the response, which is sent to the caller. The caller, in turn, deserializes the response.

Data serialization provides a number of benefits. Two interacting microservices may exist on the same operating system, the same virtual/physical server, or two entirely different servers with heterogenous hardware. API requests and responses are typically prepared for worst-case scenario of going over the network, and hence they are serialized at one end and deserialized at the other. Also, the microservices can be implemented in different programming languages so their representations for common API request and response data structures may be different. Language agnostic data serialization formats such as Protocol Buffers (Protobuf) serve as a common intermediate language. For these reasons, data serialization is performed regardless of where the API caller and callee reside in the datacenter-even if they reside on the same operating system instance and uses the same programming language.

Due to the large volumes of internal API request/response traffic in a datacenter, data serialization overhead increases quite dramatically, even for a single request/response. Additionally, well-designed and self-contained microservices cater to only a specific aspect of the application and business logic (hence, the term “micro”), so the actual processing time for an API request is often low—at millisecond or even microsecond time scales, which has led to the coinage of the term “microsecond RPCs”. As a result, in an end-to-end API request-response cycle, the data serialization overheads become significant compared to the actual business logic processing.

It has been reported that Google's datacenter serialization and RPCs account for 12% of all fleet cycles across all applications. Thus, it is apparent that such data serialization adds significant overhead resulting in increased latency and wasted processing cycles, and hence power.

### SUMMARY

The present disclosure introduces optimizations in the API software layer (e.g., API framework libraries) to avoid API traffic data serialization overheads in scenarios where it is feasible. The optimizations enable the API framework to make a decision whether to serialize an API request or response by utilizing information from the control plane platform (e.g., orchestration system), as well as exchanging information through the existing preamble procedures performed by API frameworks and protocols, before sending the API request or response. Eliminating the need for serialization and deserialization for every request and response reduces data transfer latency and results in savings in processing cycles and power. The modifications to the API framework are transparent to the microservices application and require changes only in the API framework.

A first aspect of the disclosure comprises methods implemented by a client in a microservices-based communication network for exchanging API request and responses with a server. The method comprises receiving information indicative of data transfer capabilities supported by a server API framework for communication of API requests/responses between the client and the server. The method further comprises determining, based on the received information, that a client API framework and the server API framework support a same data transfer mode and a same in-memory representation of the API requests/responses. The method further comprises, responsive to the determining, establishing a direct memory access channel for communication of the API requests/responses between the client and server using the same in-memory representation of the API requests/responses. The method further comprises exchanging API messages with the server using the direct memory access channel.

A second aspect of the disclosure a client in a microservices-based communication network configured to exchange API request and responses with a server. The client is configured to receive information indicative of data transfer capabilities supported by a remote API framework in the server for communication of API requests/responses between the client and the server. The client is further configured to determine, based on the received information, that a client API framework and the server API framework support a same data transfer mode and a same in-memory representation of the API requests/responses. The client is further configured to, responsive to the determining, establish a direct memory access channel for communication of the API requests/responses between the client and server using the same in-memory representation of the API requests/responses. The client is further configured to exchange API messages with the server using the direct memory access channel.

A third aspect of the disclosure comprises a computing device in a microservices-based communication network configured to exchange API request and responses with a server. The computing device comprises interface circuitry for communicating with a server and processing circuitry operatively coupled to the interface circuitry. The processing circuitry is configured to receive information indicative of data transfer capabilities supported by a server API framework for communication of API requests/responses between the client and the server. The processing circuitry is further configured to determine, based on the received information, that a client API framework and the server API framework support a same data transfer mode and a same in-memory representation of the API requests/responses. The processing circuitry is further configured to, responsive to the determining, establish a direct memory access channel for communication of the API requests/responses between the client and server using the same in-memory representation of the API requests/responses. The processing circuitry is further configured to exchange API messages with the server using the direct memory access channel.

A fourth aspect of the disclosure comprises a computer program for a client running on a computing device. The computer program comprises executable instructions that, when executed by processing circuitry in a computing device, causes the computing device to perform the method according to the first aspect.

A fifth aspect of the disclosure comprises a carrier containing a computer program according to the fourth aspect. The carrier is one of an electronic signal, optical signal, radio signal, or a non-transitory computer readable storage medium.

A sixth aspect of the disclosure comprises methods implemented by an orchestrator or other management function in a microservices-based communication network of optimizing data exchange between a client and server. The method comprises deploying a client and a server configured to use direct memory transfer for the exchange of API request/response with a server. The method further comprises receiving, from the client, a query for data transfer capabilities of an API server framework of the server. The method further comprises providing, to the client and responsive to the query, information indicative of the data transfer capabilities supported by the server API framework for communication of API requests/responses between the client and the server.

A seventh aspect of the disclosure comprises a management function in a microservices-based communication network for optimizing data exchange between a client and server. The management function is configured to deploy a client and a server configured to use direct memory transfer for the exchange of API request/response with a server. The management function is further configured to receive, from the client, a query for data transfer capabilities of an API server framework of the server. The management function is further configured to providing, to the client and responsive to the query, information indicative of the data transfer capabilities supported by the server API framework for communication of API requests/responses between the client and the server.

An eighth aspect of the disclosure comprises a computing device in a microservices-based communication network optimizing data exchange between a client and server. The computing device comprises interface circuitry for communicating with a server and processing circuitry operatively coupled to the interface circuitry. The processing circuitry is configured to deploy a client and a server configured to use direct memory transfer for the exchange of API request/response with a server. The processing circuitry is further configured to receive, from the client, a query for data transfer capabilities of an API server framework of the server. The processing circuitry is further configured to providing, to the client and responsive to the query, information indicative of the data transfer capabilities supported by the server API framework for communication of API requests/responses between the client and the server.

A ninth aspect of the disclosure comprises a computer program for an orchestrator or management function running on a computing device. The computer program comprises executable instructions that, when executed by processing circuitry in the host device, causes the data analytics system to perform the method according to the sixth aspect.

A tenth aspect of the disclosure comprises a carrier containing a computer program according to the ninth aspect. The carrier is one of an electronic signal, optical signal, radio signal, or a non-transitory computer readable storage medium.

### BRIEF DESCRIPTION OF THE DRAWINGS

FIG. 1 illustrates the data plane in a conventional microservices-based architecture using data serialization for exchange of API requests and responses.

FIG. 2 illustrates a microservices-based architecture with an optimized data plane for exchange of API requests and responses.

FIG. 3 illustrates a microservices-based architecture including a load balancer.

FIG. 4 is a sequence diagram for data plane optimization according to a first embodiment.

FIG. 5 is a sequence diagram for data plane optimization according to a first embodiment.

FIG. 6 illustrates a method of data plane optimization implemented by a client.

FIG. 7 illustrates an exemplary client configured for data plane optimization.

FIG. 8 illustrates a method of data plane optimization implemented by orchestrator.

FIG. 9 illustrates an exemplary orchestrator configured for data plane optimization.

FIG. 10 illustrates the main functional components of a computing device in a microservices-based architecture that can be configured to implement a client and/or server.

### DETAILED DESCRIPTION

The present disclosure provides techniques to optimize communications between microservices to reduce overhead and latency. Conventionally, the data-plane API interactions, i.e., requests and responses, between microservices involve some form of data serialization, which adds to the overhead, increases data transfer latency, and increases required processing cycles and power. In embodiments of the present disclosure, the API framework acquires information about the available servers, such as the server locations, available data transfer modes, and supported in-memory representations of API requests/response structures, i.e., API data structures. Information about the server locations is obtained from the cloud control plane or load balancer. Information about supported data transfer modes and API data structures can be obtained from the cloud control plane or load balancer, or through exchange of information between the client-side and server-side API frameworks. Based on this information, the client-side API framework selects a transport mechanism for communication of API requests/response between the client and server. If the client and server reside on the same operating system and support the same API data structures, a shared memory can be used for transfer of API requests/responses. If the client and server reside on different physical servers, but support the same API data structures, an optimized channel can be set up using Remote Direct Memory Access (RDMA). RDMA enables direct memory access from the memory of one computer into that of another without involving either processor, cache or operating system of either computer. If these options are not available, a default channel using HTTP/REST can be used for communication of API requests/responses.

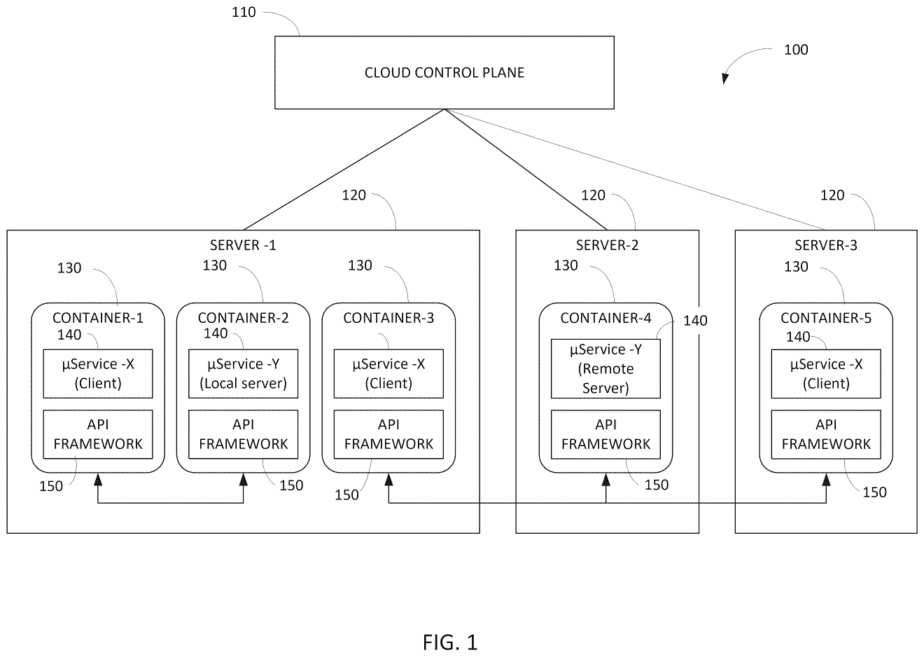

FIG. 1 illustrates an exemplary cloud computing environment with three cloud servers 120, denoted as Server-1 through Server-3, supported by a common control plane 110. The cloud servers 120 may comprise physical servers or virtual machines (VMs) forming a cluster according to an orchestration system such as Kubernetes. Each server 120 runs an operating system that can support multiple containers 130, denoted as Container 1 through Container-5. Each container 130 implements an instance of a microservice 140, which enables rapid scaling of services by adding or removing containers 130 depending on demand. In this example, Container-1, -3 and -5 implement instances of client application (Microservice-X) and Containers-2 and -4 implement instances of the corresponding server application (Microservice-Y). The microservice binaries include a specific API framework 150 depending on the API protocol/language being used. The API frameworks 150 enable communication between microservices 140 implemented by different containers 130 on the same or different servers 130. In the example, the API framework implements a Remote Procedure Call (RPC) and is also referred to herein as the RPC framework. RPC is a software communication protocol that one program can use to request a service from a program located in another computer on a network without having to understand the network's details. Thus, the RPC framework is one example of an API framework implementing the RPC protocol.

In the example shown in FIG. 1, an instance of Microservice-X in Container-1 has an established connection with an instance of Microservice-Y in Container-2 on the same server 120. In this case, the API requests are served from a local server. The instances of Microservice-X in Container-3 and Container-5 both have an established connection with the instance of Microservice-Y in Container 4 on a different server 120. In this case, the API requests are served from a remote server. Even though the API requests from the instance of Microservice-X in Container-1 are served locally, the requests and responses are nevertheless serialized, which adds to the signaling overhead. Also, the API requests from the instances of Microservice-X in Container-3 and Container-5 are serialized even where the instance of Microservice-Y supports the same in-memory representation of API request/response structures.

One aspect of the present disclosure is to provide a mechanism to enable non-serialized communication between microservices running on the same or different servers in cases where direct memory transfer of API requests/responses is supported and where the client and server applications support the same in-memory representation of API request/response structures. Generally, the client-side API obtains information about the server location and capabilities, i.e., supported data transfer modes and API data structures, by exchanging messages with the cloud control plane and possibly the server-side API framework during establish of an initial channel for exchange of API requests/responses using a default protocol such as HTTP/REST. Based on this information, the client-side API framework selects a transport mechanism for communication of API requests/response between the client and server. If the client and server reside on the same operating system and support the same API data structures, a shared memory can be used for transfer of API requests/responses. If the client and server reside on different physical servers, but support the same API data structures, an optimized channel can be set up using Remote Direct Memory Access (RDMA). If these options are not available, a default channel using HTTP/REST can be used for communication of API requests/responses.

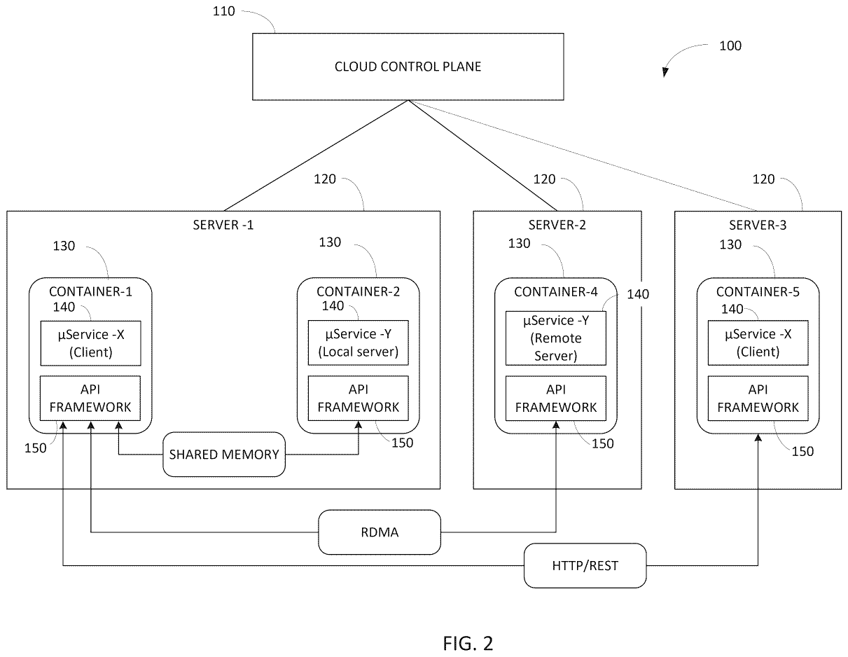

FIG. 2 illustrates a cloud computing environment with data plane optimizations for exchange of API requests/responses. The cloud computing environment includes three cloud servers 120, denoted as Server-1 through Server-3, supported by a common control plane 110. An instance of Microservice-X is running in Container-1 on Server-1. An instance of Microservice-Y is running in Container-2, Container-4 and Container-5 on Server-1, Server-2, and Server-3 respectively. In this example, it is assumed that the API frameworks for Container-2 and Container-4 support the same in-memory representation of API-request/response structures as the API framework for Container-1, while the API framework for Container-5 does not. It is also assumed that the instance of Microservice-Y in Container-4 supports RDMA.

Because Container-1 and Container-2 are running on the same operating system and have access to the same memory, a shared memory space is setup for use by the instance of Microservice-X in Container-1 and the instance of Microservice-Y in Container-2 to exchange API requests/responses. Further, the instance of Microservice-X implemented in Container-1 and the instance of Microservice-Y in Container-4 both support RDMA and can use the same in-memory representation of API request/response structures. In this case, a RDMA connection is established between the instance of Microservice-X implemented in Container-1 and the instance of Microservice-Y in Container-4. In contrast, the instance of Microservice-Y in Container-5 does not support RDMA. In this case, a default HTTP/REST connection is established between the instance of Microservice-X implemented in Container-1 and the instance of Microservice-Y in Container-5.

In order to optimize application-level API interactions (e.g., microservice RPCs), certain steps need to be taken when the microservice binaries are compiled to enable runtime deduction of the optimal data transfer mechanism by the client-side API framework. Based on the deployment configuration parameters, the cloud orchestrator sets up the necessary environment at container instantiation, to support alternate faster transfer mechanisms like Shared Memory (e.g., via shared interprocess communication (IPC) namespace) or RDMA protocol. For Kubernetes, the configuration of the environment is achieved via device plugins and container networking interface (CNI). If the orchestrator or other management function allows on-demand requests for establishment of faster modes of transfer (shared memory or RDMA support) at runtime, the API framework can utilize such feature.

When API client and server binaries for microservices are compiled, the language-specific API framework libraries (or code-generators) are modified to store language-specific information, such as the programming language, compiler name, release/version, etc., into the generated client and server binaries. This compile time information (metadata) is exported to the control-plane and stored along with the microservice binary/images. This metadata can be used at runtime by the client-side API framework to determine whether the client and server can support the same in-memory representation of API request/response structures.

The language-specific information may include any combination of the following non-limiting information:
programming language of the server API framework;
type of a compiler for the server API framework;
version of the compiler for the server API framework;
ABI of the server API framework;
supported hardware platforms (e.g., x86, ARM, etc.)
   This information can be collected and embedded as part of the program or supplied as metadata along with the program, or through the API.

In some embodiments, the program can be compiled to support more than one format.

In some embodiments, additional information may be included to indicate compatibility or equivalency. Table 1 below shows an example of compatibility information.

TABLE 1
Example of Compatibility Information

| S. No | Program Specification | Compatibility Information |
|---|---|---|
| 1 | Lang = C++, | Lang = C++, |
| | Compiler = G++-6, | Compiler = Intel C++, |
| | ABI = 11 | ABI = 11, 12 |
| | | Lang = C++, |
| | | Compiler = LLVC, |
| | | ABI = XX, XY |
| 2 | Lang = Python, | Lang = Python, Version = 3.8 |
| | Version = 3.9 | Lang = Python, Version = 3.10 |

In some embodiments, the application developer can specify a few possible targets for the server microservice, e.g., which languages/version or architecture the server can be in the deployment, and the compiler can generate server-target-specific representations as an optimization. Another option is to store information indicating whether some language-agnostic representation is used, such as Apache Arrow.

Regardless of the deployment approach used, the compile-time optimizations enable decisions regarding whether the client and server can avoid data serializations by using the same in-memory API request/response representations or pre-generated stubs.

At runtime, API clients typically request the API framework layer to set up API request/response channels or connections with specific API servers. This request may be an explicit preamble request to the API framework. Alternatively, the request-response channel may be set up automatically responsive to the first API request sent by the client.

When the client-side API framework receives an explicit or implicit request to set up the API request/response channel, it can determine whether the API client and server can avoid serialization costs and use optimized transfer mechanisms for message exchange between the client and server. Generally, two conditions need to be satisfied to set up an optimized channel for API requests/responses. First, the client-side API framework needs to determine the supported data transfer modes for the server. As will be hereinafter described, this step involves new interactions between the data plane and control plane. Second, the client-side API framework needs to determine whether the client and server support the same in-memory representation of the API request/response structures. This step may involve interactions between the data plane and control plane, or the exchange of messages between the client-side and server-side API frameworks. If the server supports the same optimized data transfer mode and the same in-memory representation of API request/response structures, then an optimized channel can be set up for exchange of API request/responses.

In the first step, when client microservice triggers a connection request, the client-side API framework queries the control plane orchestration system (e.g., Kubernetes orchestrator) to fetch the details of the corresponding server microservices, such as the server locations (e.g., whether client and server are co-located on same operating system instance) and available data transfer modes (e.g., shared memory between co-located client and server, RDMA between client and server located on different nodes, etc.). In a non-limiting example of a Kubernetes environment, the API framework can query the Kubernetes API server. The orchestration system or control plane already has information about the API service names, service IP address(es), ports, service location among the cluster nodes, and possible modes of communication (e.g., traditional HTTP-HTTP/2, RDMA, shared memory, etc.) The cloud control plane resolves the query by responding with the details of the server microservice including location information (service IP and port address, server details, etc.), and available modes of data transfer, which may include shared memory (if located on same operating system); RDMA (if the server and client can communicate via InfiniBand or RDMA over Converged Ethernet (RoCE)), or HTTP/TCP (default). As an example, in order to use shared memory, the containers must have shared IPC namespace, which may be a deployment configuration also known to the orchestration system.

The second step, determining whether the same in-memory representation is supported, can involve interaction with the control plane or can be based on exchanged preamble information between the client-side and server-side API frameworks. In the control plane approach, the client-side API framework initially queries the control plane to retrieve the server-side language identity-specific information (such as programming language, version, server-side endianness, etc.). The control-plane responds with server-identity-specific information indicating services with the capability of supporting the same in-memory representations of API request/response structures. In some embodiments, the server-identity specific information can be a separate query-response between the client and control-plane. Alternatively, the control plane may provide the server-identity specific information in answer to the initial query so no additional query is required.

In the preamble exchange approach, the client-side API framework initiates and negotiates an initial connection using a default protocol (e.g., HTTP, HTTP/2, etc.) with the server-side API framework. The client and server exchange preamble information, which includes language specific information and API related information. During this negotiation, the client-side API framework sends language-identity-specific information to the server about the API client's language identity-specific information. The server-side API framework responds with similar server-side information. As a result, each side knows whether the same in-memory representation is supported. Based on the exchanged preamble information, the client-side RPC framework will decide the best possible mode of data transfer mechanism.

The client-side API framework can choose ‘Shared Memory’ as the preferred mode of transport if the server is co-located on same operating system and can support same in-memory representation. As an illustrative mechanism, if the client-side API framework determines that the client and server have the same IPC namespace for shared memory and support the same in-memory representations of the requests and responses, the client API framework can request the server to create and share the details of the shared memory region. In response, the server-side API framework creates a shared memory segment and shares the shared memory region key or identifier with the client-side API framework via the existing (default) communication channel. Both client-side and server-side API frameworks can map the shared memory region to their address spaces, and then can use the shared memory for exchanging API requests and responses, which is faster without the need for serialization.

Note that the server can create a common, large, shared memory pool among multiple clients (with appropriate locking) or may set up per-client shared memory. Data encryption between the client and server is not affected; the client and server can choose to have in-memory data encrypted if they choose to.

If the server is not co-located with the client, but supports the same in-memory representation, the client API framework selects ‘RDMA’ as the preferred mode of transport. The client API framework can request the server API framework to setup server-side RDMA. Responsive to the request, the server-side API framework creates a RDMA memory region, send-receive queue pairs and completion queues, and listens for connection request from the client. Server-side API framework exchanges RDMA related details with the client via the existing (default) communication channel. Meanwhile, the client sets up the RDMA channel, and connects and establishes a connection with the RDMA server. Once this channel is established, the API calls exchanged between the corresponding server and client can be transported using RDMA without the need for serialization.

If no alternative faster transport mechanisms is available, the client and server continue to communicate API calls via the default mechanism (e.g., HTTP, HTTP/2).

Once the initial setup is complete, the API frameworks are ready to use the alternate transfer mechanism (e.g., shared memory) for sharing API requests and responses directly without serialization and protecting them appropriately with locks as required.

The optimized data plane as herein described has minimal impact on the existing failure handling mechanisms in such API frameworks or control plane, or impose additional requirements. For instance, in case of a microservice or container failing, the cloud orchestrator will normally re-instantiate the microservice (not necessarily on the same node). Moreover, the state-of-art API framework libraries typically attempt re-discovery of peer/server and/or API retries. Thus, in such scenarios, the client API framework would simply repeat the process of establishing connections (or establishing faster modes of transfer) with the server, for which, as described earlier, they will query the control plane etc. to fetch the best peer/server details and follow the steps to establish faster communication channel, if feasible.

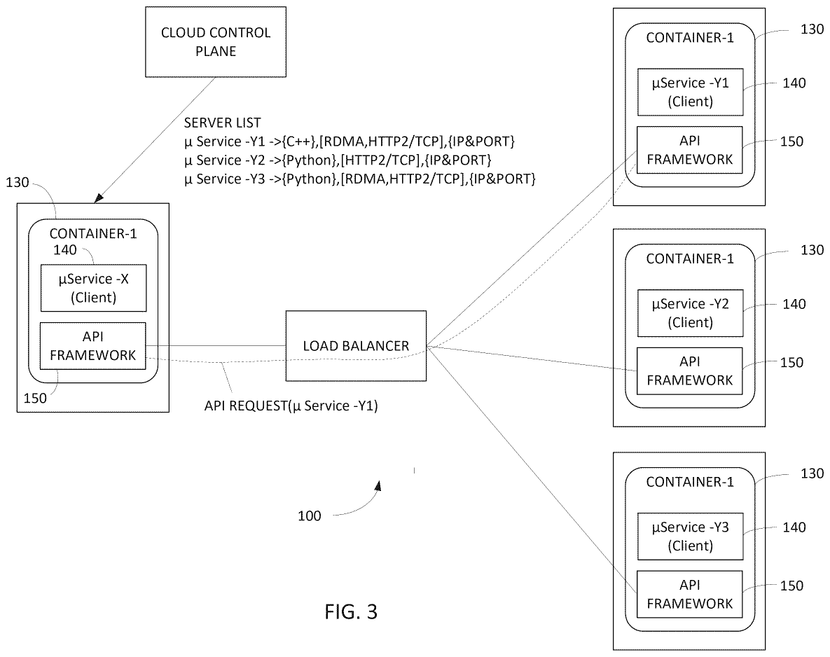

FIG. 3 illustrates a scenario where the microservice communicate through a load balancer. The control-plane provides a list of potential remote-services to which the client can connect. The client chooses a suitable candidate from the list and sends a request to establish the connection. The request includes an indication of the selected server microservice. Upon reception of the request, load-balancer forwards the message transparently to the destination based on the destination information present in the client request. If there is no destination specified in the request, load-balancer could use suitable information and algorithm to deduce the remote-service and forward the connection request.

In the presence of a load balancer in the deployment to spread the client RPC requests over a pool of RPC server instances, the API client framework could query the load-balancer and the control plane to connect to the best-possible instance of the API server microservice. Criteria for deciding on the best instance could be both client and server location, as well as other metadata about client and server available to the control plane and load balancer (e.g., metadata tags for client and server language/release information).

In some embodiments, the API framework can influence decision-making by the control plane and load balancer: Rather than the client-side API framework libraries only querying information, certain optimizations for low-latency interaction can be influential in nature. For low latency scenarios, the API framework/libraries can make recommendations to the control plane or load balancer or otherwise influence the control plane and load balancing decisions to connect to the server instances preferred by the client API framework.

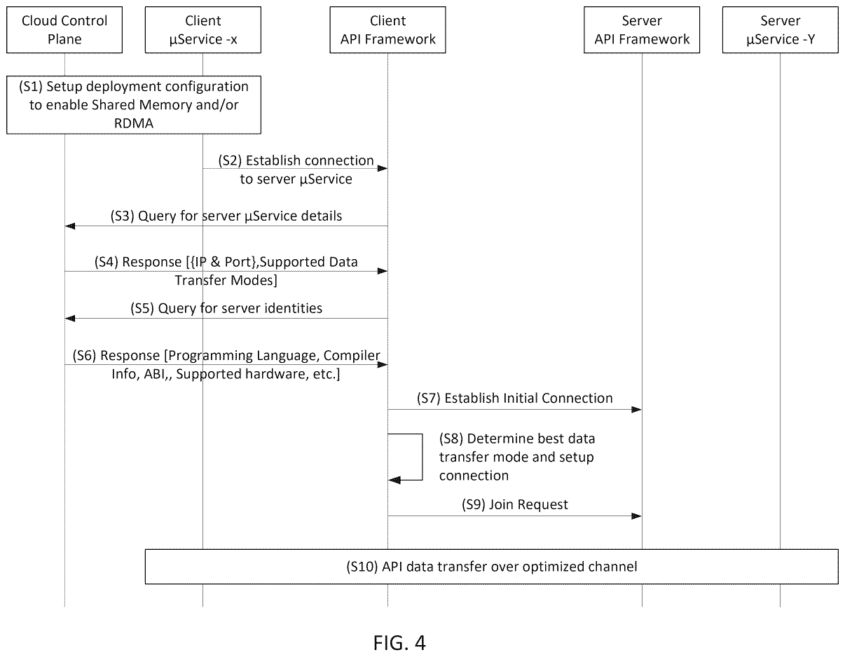

FIG. 4 illustrates an exemplary procedure using control plane querying to obtain information to set up optimized data transfer. The cloud control plane instantiates the client and server microservices with the required binaries to enable Shared Memory and RDMA and stores necessary information about the deployment configuration (S1). Following deployment, the client application initiates connection establishment with the server application by sending an explicit request to the client API framework or by sending a client request (S2). The client-side API queries the control plane to fetch information about the server details (S3). The control plane answers with the service location (e.g., IP address and port) and available modes of data transfer for one or more servers (S4). The client-side API framework sends a second query to the control plane to obtain information about the server identities indicating services capable of supporting the same in-memory representations of API requests/responses (S4). In response, the control plane provides server-specific information such as the programming language, endianness, etc. (S5). Based on the obtained information, the client-side API framework deduces the preferred server instance and establishes an initial connection with the preferred server instance using a default protocol such as HTTP/REST (S6). Once the default connection is set up, the client-side API initiates set up of an optimized channel and invites the selected server instance to join (S7). The selected server instance can then join and switch to the optimized channel (S8). Thereafter, the optimized channel can be used by the client and server to exchange API requests and response (S9).

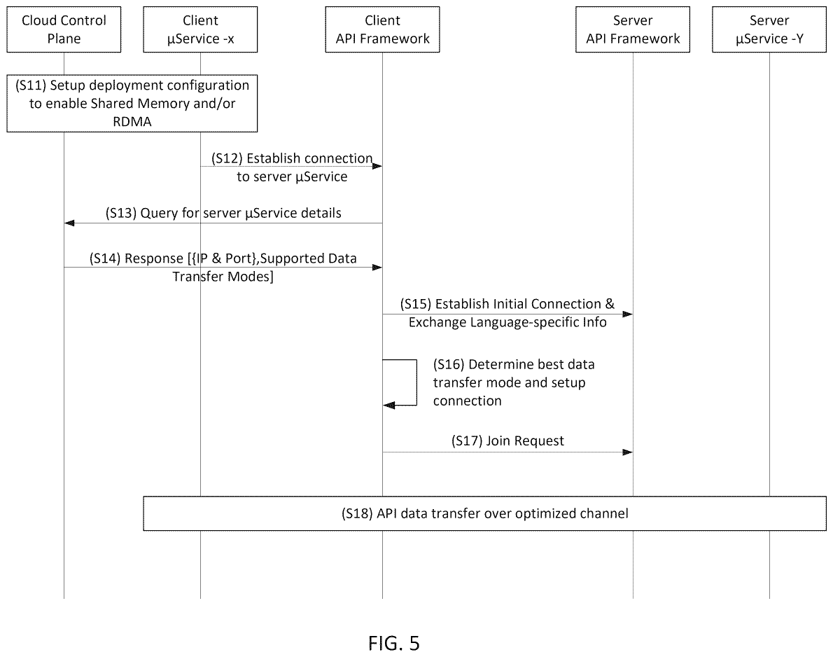

FIG. 5 illustrates an exemplary procedure using preamble exchange to obtain information to set up optimized data transfer. The cloud control plane instantiates the client and server microservices with the required binaries to enable Shared Memory and RDMA and stores necessary information about the deployment configuration (S11). Following deployment, the client application initiates connection establishment with the server application by sending an explicit request to the client API framework or by sending a client request (S12). The client-side API queries the control plane to fetch information about the server details (S13). The control plane answers with the service location (e.g., IP address and port) and available modes of data transfer for one or more servers (S14). The client-side API framework establishes an initial connection with the preferred server instance using a default protocol such as HTTP/REST (S15). During negotiation of the initial connection, the client and server API frameworks exchange information about server-specific and language-specific details such as programming languages, endianness, etc., (S16). Based on the information received from the control plane and during the exchange with the server-side API framework, the client-side API framework deduces the preferred method of data transfer and establishes an optimized channel for the exchange of API requests/responses (S17). The selected server instance can then join and switch to the optimized channel. Thereafter, the optimized channel can be used by the client and server to exchange API requests and response (S18).

The basic procedures shown in FIGS. 3 and 4 can be easily modified to allow the server-side API framework to select the preferred data transfer mode.

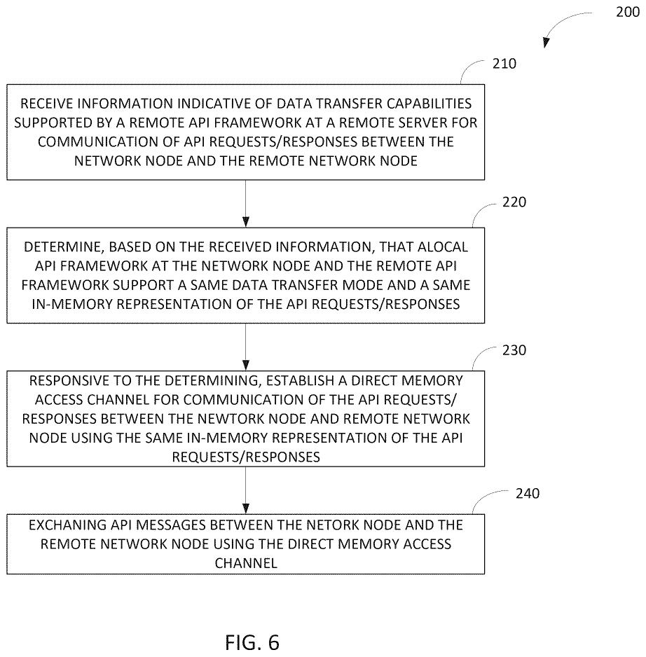

FIG. 6 illustrates an exemplary method 200 of transferring data between a client and a server. As used herein, a client is an instance of a client or server microservice implemented in a cloud server, which may comprise a physical server, VM, or container. The client receives information indicative of data transfer capabilities supported by a remote API framework in the server for communication of API requests/responses between the client and the server, which can reside on the same server or on a different server (block 210). The server can reside on the server as the client. The client determines, based on the received information, that a client API framework and the server API framework support a same data transfer mode and a same in-memory representation of the API requests/responses (block 220). Responsive to the determining, the client establishes a direct memory access channel for communication of the API requests/responses between the client and server using the same in-memory representation of the API requests/responses (block 230). The client exchanges API messages with the server using the direct memory access channel (block 240).

Some embodiments of the method 200 further comprise establishing an initial connection for communication of API requests/responses between client and server using data serialization.

In some embodiments of the method 200, receiving information indicative of the available data transfer capabilities supported by the remote API framework for communication of API requests/responses between client and server comprises receiving, from a control plane entity, information indicative of available data transfer modes supported by the remote API framework.

In some embodiments of the method 200, receiving information indicative of the available data transfer capabilities supported by the remote API framework for communication of API requests/responses between the client and server further comprises receiving, from the control plane entity, information indicative of available languages supported by the remote API framework.

In some embodiments of the method 200, receiving information indicative of the available data transfer capabilities supported by the remote API framework for communication of API requests/responses between client and server further comprises receiving, from the remote API framework, information indicative of available languages supported by the remote API framework.

Some embodiments of the method 200 further comprise receiving location information indicative of a location of the server.

In some embodiments of the method 200, establishing a direct memory access channel for communication of the API requests/responses between client and server comprises determining, based on the location information, that the client and server have access to a shared memory and establishing the direct memory access channel using the shared memory.

In some embodiments of the method 200, establishing the direct memory access channel using the shared memory comprises sending a request to the remote API framework over an initial connection to set up shared memory access, receiving, over the initial connection, configuration information from the remote API framework indicative of a shared memory region for shared memory access, and mapping the shared memory region to an address space of the local API framework.

In some embodiments of the method 200, establishing a direct memory access channel for communication of the API requests/responses between the client and server comprises determining, based on the location information, that the client and server do not have access to a same shared memory and establishing the direct memory access channel using a remote memory of the server.

In some embodiments of the method 200, establishing the direct memory access channel using the shared memory comprises sending a request to the remote API framework over an initial connection to set up remote direct memory access (RDMA), receiving, over the initial connection, configuration information from the remote API framework for a RDMA connection, and establishing the RDMA connection using the configuration information.

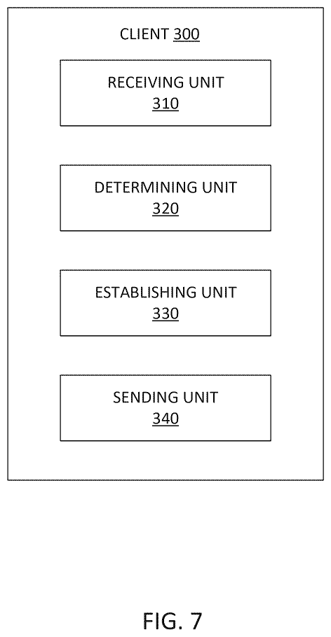

FIG. 7 illustrates a client 300 according to an embodiment. The client 300 comprises a receiving unit 310, determining unit 320, establishing unit 330, and exchanging unit 340. The various units 310-340 may comprises one or more processors, hardware, firmware, software or a combination thereof. The receiving unit 310 is configured to receive information indicative of data transfer capabilities supported by a server API framework for communication of API requests/responses between the client and the server. The determining unit 320 is configured to determine, based on the received information, that a client API framework and the server API framework support a same data transfer mode and a same in-memory representation of the API requests/responses. The establishing unit 330 is configured to, responsive to the determining, establish a direct memory access channel for communication of the API requests/responses between the client and server using the same in-memory representation of the API requests/responses. The exchanging unit 340 is configured to exchange API messages with the server using the direct memory access channel.

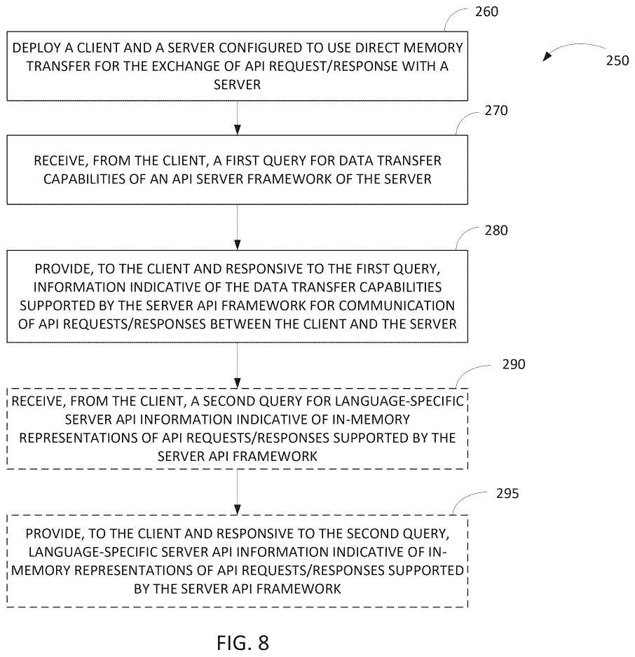

FIG. 8 illustrates a method 250 implemented by an orchestrator or other management function in a microservices-based communication network of optimizing data transfer between a client and a server. The orchestrator deploys a client and a server configured to use direct memory transfer for the exchange of API request/response with a server (block 260). The orchestrator further receives, from the client, a first query for data transfer capabilities of an API server framework of the server (block 270). Responsive to the first query, the orchestrator provides to the client information to the indicative of the data transfer capabilities supported by the server API framework for communication of API requests/responses between the client and the server (block 280).

In some embodiments of the method 250, providing, responsive to the first query, information to the client indicative of the data transfer capabilities supported by the server API framework comprises the client with data transfer modes supported by the server API framework.

Some embodiments of the method 250 further comprise receiving, from the client, a second query for language-specific server API information indicative of in-memory representations of API requests/responses supported by the server API framework (block 290). In this embodiment, the management function provides, to the client and responsive to the second query, language-specific server API information indicative of in-memory representations of API requests/responses supported by the server API framework (block 295).

In some embodiments of the method 250, providing, responsive to the first query, information to the client indicative of the data transfer capabilities supported by the server API framework comprises the client with: data transfer modes supported by the server API framework and language-specific server API information indicative of in-memory representations of API requests/responses supported by the server API framework.

In some embodiments of the method 250, the language-specific server API information comprises one or more of the following: programming language of the server API framework; type of a compiler for the server API framework; version of the compiler for the server API framework; ABI of the server API framework; supported hardware platforms.

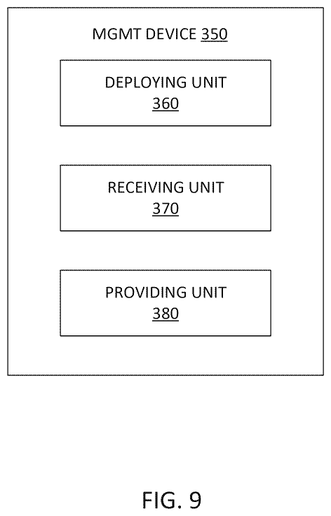

FIG. 9 illustrates a management function 350 according to an embodiment. The management function 350 comprises a deploying unit 360, receiving unit 370, and responding unit 380. The various units 360-380 may comprises one or more processors, hardware, firmware, software or a combination thereof. The deploying unit 360 is configured to deploy a client and a server configured to use direct memory transfer for the exchange of API request/response with a server. The receiving unit 370 is configured to receive, from the client, a first query for data transfer capabilities of an API server framework of the server. The responding unit 380 is configured to receive, from the client, a first query for data transfer capabilities of an API server framework of the server.

In some embodiments, the receiving unit is further configured to receive, from the client, a second query for language-specific server API information indicative of in-memory representations of API requests/responses supported by the server API framework. In this embodiment, the providing unit 370 is further configured to provide, to the client and responsive to the second query, language-specific server API information indicative of in-memory representations of API requests/responses supported by the server API framework.

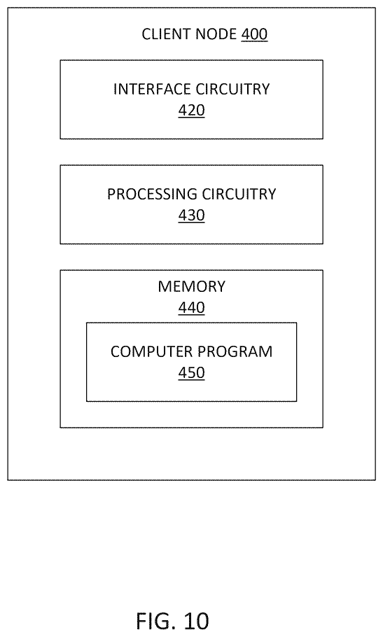

FIG. 10 illustrates a host device 400 according to an embodiment. The host device 400 can be configured to function as a client, a server, or as a management function as herein described. The host device 400 comprises interface circuitry 420 to enable communication with other network nodes in the communication network, processing circuitry 430 to control the operation of the network node 400, and memory 440 to store computer programs and data needed for operation.

The interface circuitry 420 couples the host device 400 to a communication network for communication with other network nodes in the wireless communication network. The interface circuitry 420 may comprise a wired or wireless interface operating according to any standard, such as the Ethernet, Wireless Fidelity (WiFi) and Synchronous Optical Networking (SONET) standards.

The processing circuitry 430 controls the overall operation data analytics system 300. The processing circuitry 430 may comprise one or more microprocessors, hardware, firmware, or a combination thereof. In some embodiments, the host device is configured to serve as a client. When configured to as a client, the processing circuitry 430 is configured to query the control plane and exchange data with the server as herein described. In one embodiment, the processing circuitry 430 is configured to perform the method 200 of FIG. 6. In other embodiments, the host device 400 is configured to serve as an orchestrator or other management function. When configured to as an orchestrator, the processing circuitry 430 is configured to deploy the clients and servers, and the respond to queries from the client as herein described. In one embodiment, the processing circuitry 430 is configured to perform the method 250 of FIG. 8.

Memory 440 comprises both volatile and non-volatile memory for storing computer program code and data needed by the processing circuitry 430 for operation. Memory 440 may comprise any tangible, non-transitory computer-readable storage medium for storing data including electronic, magnetic, optical, electromagnetic, or semiconductor data storage. Memory 440 stores computer program 450 comprising executable instructions that configure the processing circuitry 430 to implement the method 200 according to FIG. 6 (for the client function) or the method 250 of FIG. 8 (for ta management function) as described herein. A computer program 450 in this regard may comprise one or more code modules corresponding to the means or units described above. In general, computer program instructions and configuration information are stored in a non-volatile memory, such as a ROM, erasable programmable read only memory (EPROM) or flash memory. Temporary data generated during operation may be stored in a volatile memory, such as a random access memory (RAM). In some embodiments, computer program 450 for configuring the processing circuitry 430 as herein described may be stored in a removable memory, such as a portable compact disc, portable digital video disc, or other removable media. The computer program 450 may also be embodied in a carrier such as an electronic signal, optical signal, radio signal, or computer readable storage medium.

Those skilled in the art will also appreciate that embodiments herein further include corresponding computer programs. A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

1. A method implemented by a client for exchanging API messages with a server, the method comprising:
receiving information indicative of data transfer capabilities supported by a remote API framework in the server for communication of API requests/responses between the client and the server;
determining, based on the received information, that a client API framework and the server API framework support a same data transfer mode and a same in-memory representation of the API request/response structures;
responsive to the determining, establishing a direct memory access channel for communication of the API requests/responses between the client and server using the same in-memory representation of the API requests/responses; and
exchanging API messages with the server using the direct memory access channel and same in-memory representation of API requests/response structures.

2. The method of claim 1, further comprising, establishing an initial connection for communication of API requests/responses between client and server using data serialization.

3. The method of claim 1, wherein receiving information indicative of the available data transfer capabilities supported by the remote API framework for communication of API requests/responses between client and server comprises:
receiving, from a control plane entity, information indicative of available data transfer modes supported by the remote API framework.

4. The method of claim 3, wherein receiving information indicative of the available data transfer capabilities supported by the remote API framework for communication of API requests/responses between the client and server further comprises:
receiving, from the control plane entity, information indicative of available languages supported by the remote API framework.

5. The method of claim 1, wherein receiving information indicative of the available data transfer capabilities supported by the remote API framework for communication of API requests/responses between client and server further comprises:
receiving, from the remote API framework, information indicative of available languages supported by the remote API framework.

6. The method of claim 1, further comprising receiving location information indicative of a location of the server.

7. The method of claim 6, wherein establishing a direct memory access channel for communication of the API requests/responses between client and server comprises:
determining, based on the location information, that the client and server have access to a shared memory; and
establishing the direct memory access channel using the shared memory.

8. The method of claim 7, wherein establishing the direct memory access channel using the shared memory comprises:
sending a request to the remote API framework over the initial connection to set up shared memory access; and
receiving, over the initial connection, configuration information from the remote API framework indicative of a shared memory region for shared memory access; and
mapping the shared memory region to an address space of the local API framework.

9. The method of claim 6, wherein establishing a direct memory access channel for communication of the API requests/responses between the client and server comprises:
determining, based on the location information, that the client and server do not have access to a same shared memory; and
establishing the direct memory access channel using a remote memory of the server.

10. The method of claim 9, wherein establishing the direct memory access channel using the shared memory comprises:
sending a request to the remote API framework over the initial connection to set up remote direct memory access (RDMA); and
receiving, over the initial connection, configuration information from the remote API framework for a RDMA connection; and
establishing the RDMA connection using the configuration information.

11. (canceled)

12. (canceled)

13. (canceled)

14. (canceled)

15. (canceled)

16. (canceled)

17. A non-transitory computer-readable storage medium containing a computer program comprising executable instructions that, when executed by a processing circuit in a client computing device causes the client computing device to perform a method comprising:
receiving information indicative of data transfer capabilities supported by a remote API framework in the server for communication of API requests/responses between the client and the server;
determining, based on the received information, that a client API framework and the server API framework support a same data transfer mode and a same in-memory representation of the API request/response structures;
responsive to the determining, establishing a direct memory access channel for communication of the API requests/responses between the client and server using the same in-memory representation of the API requests/responses; and
exchanging API messages with the server using the direct memory access channel and same in-memory representation of API requests/response structures.

18. A method implemented by a management function in a microservices-based communication network, the method comprising:
deploying a client and a server configured to use direct memory transfer for the exchange of API request/response with a server;
receiving, from the client, a first query for data transfer capabilities of an API server framework of the server; and
providing, to the client and responsive to the first query, information indicative of the data transfer capabilities supported by the server API framework for communication of API requests/responses between the client and the server.

19. The method of claim 18, wherein providing, responsive to the first query, information to the client indicative of the data transfer capabilities supported by the server API framework comprises providing the client with data transfer modes supported by the server API framework.

20. The method of claim 19, further comprising:
receiving, from the client, a second query for language-specific server API information indicative of in-memory representations of API requests/responses supported by the server API framework; and
providing, to the client and responsive to the second query, language-specific server API information indicative of in-memory representations of API requests/responses supported by the server API framework.

21. The method of claim 19, wherein providing,
responsive to the first query, information to the client indicative of the data transfer capabilities supported by the server API framework further comprises providing the client with:
language-specific server API information indicative of in-memory representations of API requests/responses supported by the server API framework.

22. The method of claim 21, wherein the language-specific server API information comprises one or more of the following:
programming language of the server API framework;
type of a compiler for the server API framework;
version of the compiler for the server API framework;
ABI of the server API framework;
supported hardware platforms.

23. (canceled)

24. (canceled)

25. (canceled)

26. (canceled)

27. (canceled)

28. (canceled)

29. A non-transitory computer-readable storage medium containing a computer program comprising executable instructions that, when executed by a processing circuit in a computing device causes the computing device to perform a method comprising:
deploying a client and a server configured to use direct memory transfer for the exchange of API request/response with a server;
receiving, from the client, a first query for data transfer capabilities of an API server framework of the server; and
providing, to the client and responsive to the first query, information indicative of the data transfer capabilities supported by the server API framework for communication of API requests/responses between the client and the server.
